(19) United States
(12) Patent Application Publication
(10) Pub. No.: US 2018/0302324 A1
(43) Pub. Date: Oct. 18, 2018

(54) PACKET FORWARDING MECHANISM

(71) Applicant: Atsushi Kasuya, Los Altos, CA (US)

(72) Inventor: Atsushi Kasuya, Los Altos, CA (US)

(21) Appl. No.: 15/956,733

(22) Filed: Apr. 18, 2018

Related U.S. Application Data
(60) Provisional application No. 62/486,948, filed on Apr. 18, 2017.

(51) Int. Cl. H04L 12/741

(52) U.S. Cl. CPC H04L 45/745

(57) ABSTRACT

Effective data distribution without special hardware such as CAM. A unique Route ID in the network is used to determine the destinations for a sent packet. On creating the routing information for the Route ID, each node in the network creates an entry in its own forwarding table within the node. A linear memory offset in the table, called LookUp ID, is used to access the entry. By exchanging the LookUp ID with neighboring nodes and updating the forwarding table entry, the packet distribution path can be determined for the given Route ID. When a packet is sent for the given Route ID, each node updates the predetermined field in the packet with neighbor LookUp ID and sends it to the neighbor node, so the neighbor node can access its own entry as a regular memory access with the LookUp ID to determine where to forward the packet.

### CROSS-REFERENCE TO RELATED APPLICATIONS

This application claims the benefit under 35 U.S.C. § 119(e) of U.S. Provisional Application No. 62/486,948, filed Apr. 18, 2017, and entitled PACKET FORWARDING MECHANISM, and is related to U.S. Provisional Application No. 61/893,285, entitled A FRAMEWORK FOR EARTH COMPUTING, filed on Oct. 21, 2013, U.S. application Ser. No. 14/331,225, filed on Jul. 15, 2014, U.S. Provisional Application No. 61/846,602, entitled EARTH COMPUTING, filed on Jul. 15, 2013, and U.S. Provisional Application No. 61/913,302, entitled EARTH COMPUTING, VARIOUS EMBODIMENTS & METHODS, filed on Dec. 8, 2013, the entire contents of each being incorporated herein by reference.

### FIELD OF THE INVENTION

The present invention generally relates to systems and methods for communication between networking systems, and, more particularly, relates to a mesh networked system formed with multiple networking nodes connected each other via one to one connection via multiple ports on each node.

### BACKGROUND

In the current local networking system, MAC address is used as the destination of the packet, which represents a single node or a broadcast to all nodes in given local network. When a routing node (e.g. networking switch) exists between the sender and the target node addressed by the MAC, the appropriate entry in the routing table is looked up to forward the packet to a proper node.

At a higher layer, Internet Protocol (IP) is used. The routing table within the router node is are used to determine where to forward the packet. In general, it requires a mechanism to provide {Routing ID, Forwarding Port} pair information. In order to sustain many nodes and services at global scale, the Routing ID requires a large name space (e.g. Ethernet MAC is 48 bit, IP v6 is 128 bit), but usually actual active addresses in a given system are very sparse. So, to avoid the look up table becoming huge, a special data structure such as hash or tree is used to reduce the memory size. In such case, Routing ID to port look up takes a multi-step computational resource or special hardware that increases the system cost as well as the time to complete the look up.

To avoid traffic congestion, many network switches are used. These devices use CAM (content addressable memory) to store the switching information for the network port. Such special hardware is high cost and limited in table size. This makes it difficult to extend the connection to very large scale.

Therefore, what is needed is a robust technique for effective data distribution, without special hardware such as CAM.

### SUMMARY

The present disclosure addresses the above-mentioned shortcomings with a protocol and data structure for efficient information transfer between computational nodes connected via multiple communication ports to form a mesh network where communication from any node to all destinations is specified by a single identifier for effective data distribution without special hardware such as CAM.

Computational nodes are connected to each other via multiple point to point communication ports to form a mesh network. It provides flexible generic communication path between nodes within the mesh network. A unique routing index (Route ID) is used to represent a communication path between nodes within the mesh network. When a new Route ID is created in the system, higher level routing mechanism provides the path for the routing. A simple case is a pair of {source, destination}. This can also be a path for multicast, which gives a set of destinations {destination1, destination2, . . . }. Here, it is assumed that there is a higher communication protocol which transfers this routing information on the network. On such side communication path, the Route ID and necessary forwarding information is passed to the source, destination nodes, as well as the nodes in between. The calculation of such path is assumed to be done in the upper routing protocol/mechanism, and is not a subject of this invention.

When a node receives such a routing information, it will be a set of {Route ID, Forwarding Ports} pair, where the ports can be multiple targets including the node itself. When all the nodes within the routing path received such information, the mesh system can handle the packet transfer for the given Route ID. Each node looks up the table with Route ID, and determines where to forward the packet.

With the present technique, each node uses a linear table to store the routing information entries. The new entry is indexed directly as the memory offset within the table. This index is called the LookUp ID. Within the new entry in the routing table, the Forwarding Port to the destination is recorded. Then, via the upper routing protocol, this LookUp ID is passed to the source side of the next neighbor on this routing path. The neighbor receives the LookUp ID of next forwarding neighbor, and records it into the entry associated to Route ID, as the next Lookup ID of the forwarding port. So, each node has an entry for the Route ID with {Forwarding Port, Next LookUp ID} pair according to the routing path.

When a packet is sent from the destination, the sender looks up the entry in the lookup table. At the very beginning of the transfer, it uses a mapping mechanism to determine the table entry from the Route ID. Then, it forwards the packet to the port specified in the table entry. At this point, the sender updates a field in the packet header with the Next LookUp ID corresponding to the forwarding port. Thus, the next neighbor node will receive the packet header with the LookUp ID of its own, and it can directly lookup the Forwarding Table with LookUp ID as the direct memory offset. Each node updates the LookUp ID field in the packet header with the value associated with the forwarding port when it forwards the packet to the next node. So, all nodes can use direct table lookup, without the need for a more complex and thus slower mapping mechanism between Routing ID and the table entry.

The forwarding port information can be more than one, to support multi-cast information. The table entry also can holds Child port and Parent port with corresponding LookUp IDs to support bidirectional path with a single entry.

Advantageously, effective data distribution is achieved without special hardware such as CAM.

### BRIEF DESCRIPTION OF THE FIGURES

The present disclosure is illustrated by way of example, and not by way of limitation in the figures of the accompanying drawings in which like reference numerals are used to refer to similar elements.

FIG. 1 shows a single computational node with multiple neighbor connection ports, according to an embodiment.

FIG. 2 shows an example mesh network of computational nodes with each neighbor connected each other with a communication link, according to an embodiment.

FIG. 3 shows the route path from node A to node G, according to an embodiment.

FIG. 4 shows routing path creation over the node A to node G path, according to an embodiment.

FIG. 5 shows the Forwarding table structure, according to an embodiment.

FIG. 6 shows the Forwarding table entry construction steps, according to an embodiment.

FIG. 7 shows the relation of routing table entries in neighboring nodes, according to an embodiment.

FIG. 8 shows the Ethernet Header Usage example, according to an embodiment.

FIG. 9 shows the packet forwarding process using tables in each node, according to an embodiment.

FIG. 10 shows another example of the Forwarding table structure, with bidirectional and multicast path support, according to an embodiment.

FIG. 11 shows the Forwarding table entry construction steps for the bidirectional transfer support, according to an embodiment.

FIG. 12 shows the relation of routing table entries in neighboring nodes for bidirectional transfer support, according to an embodiment.

FIG. 13 shows the Ethernet Header Usage example for bidirectional transfer support, according to an embodiment.

FIG. 14 shows the multicast table structure example, according to an embodiment.

FIG. 15 shows the flow chart for Forwarding table construction on FIG. 6, according to an embodiment.

FIG. 16 shows the flow chart for packet forwarding on FIG. 9, according to an embodiment.

FIG. 17 is a block diagram illustrating a generic computing system configured to execute the techniques described herein, according to an embodiment.

### DETAILED DESCRIPTION

This disclosure generally discloses computer-implemented methods, non-transitory computer-readable media, and devices for packet forwarding in a distributed computer system. One of ordinary skill in the art will recognize various alternatives within the spirit of this disclosure, even if not specifically discussed herein.

In one aspect, a mesh network is formed with communication nodes each having multiple communication ports. Ports are connected to ports on other nodes. A port on a node is connected to only one port on another node, in some embodiments, to distinguish the other node by its local port. A unique Route ID in the network is used to determine the destinations for a sent packet. On creating the routing information for the Route ID, each node in the network can create an entry in its own forwarding table within the node, in some embodiments. By exchanging the LookUp ID with neighboring nodes and updating the forwarding table entry, the packet distribution path can be determined for the given Route ID. When a packet is sent for the given Route ID, each node updates the predetermined field in the packet with neighbor LookUp ID and sends it to the neighbor node, so the neighbor node can access its own entry as a regular memory access with LookUp ID to determine where to forward the packet. With this mechanism, effective data distribution mechanism is achieved without special hardware such as CAM (content addressable memory).

In more detail, multiple communication nodes with multiple communication ports are connected with each other via ports to form a mesh network. The connection between any two nodes is point to point, and directly connected each other using any type of network technology such as Ethernet, PCIe, etc. This example assumes those nodes are computational servers in a data center, but the techniques can be applied to network switches used to connect such servers. In such case, the cluster of switches provides the mechanism as a network fabric to connect severs connected to the cluster. In any case, the essence of the invention is to provide an effective data transfer mechanism on a given unique network address, according to an embodiment. In this example, the address can be defined by the Route ID. This invention provides a unique data distribution path for a given logical Route ID in any addressing scheme, on top of which a conventional protocol may be overlaid.

In one embodiment, the present technique assumes the routing decision to determine where to send the data using a Route ID is done within a higher level of the networking protocol. This example does not show the higher-level protocol implementation, but existing network routing protocols such as STP, RIP, OSPF, etc. show the implementation is possible. One way of implementing such protocol is using a spanning tree. Each node first creates a spanning tree (a graph without cyclic paths) with the root as itself and uses it as the base of creating the communication substrate. The spanning tree provides a single acyclic path from a root to any nodes in the mesh. Each node runs a protocol to create the spanning tree so that each node has own spanning tree. Using this tree, a node can reach any nodes in the network mesh on a unique path.

When a node (Source Node) wants to create a communication path to a root node, first it creates a Route ID which is unique in the network mesh. Then, it allocates an entry in the forwarding table. This entry is picked from an unused table entry pool, and is accessed directly by a memory offset within the table which is called the LookUp ID. The node creates a map between the Route ID and the LookUp ID. Such map can be achieved by a hash table, but it can be done with linear search if access speed is not an issue. Then, using the path to the destination node provided by the higher routing layer, the source node sends a Route Request to the next node on the routing path to the destination node. Such request may carry information such as {Route ID, Route Path Information to the destination node}.

Each node on the path to the destination node processes the Route Request in the same way. First, it creates a new entry within its own forwarding table, accessed with a unique LookUP ID. The node creates the map between the Route ID and the LookUp ID, and write the port number to the next node on the path into the table entry. Then, it forwards the Request to the next node on the routing path. It also sends back a Route Reply message to the sending node, with information of {Route ID, LookUp ID of this node}.

On receiving the Route Reply message, the received node updates the corresponding entry in the forwarding table with the child's LookUp ID for the child port accordingly. Once the Route Request reaches the destination and all the Route Replies are returned to each connection over the routing path, a unique data distribution chain via the forwarding table entries for the Route ID is created over the mesh network nodes.

When a packet is sent from the source along the path using the Route ID, the source looks up the map to get the corresponding LookUp ID. Then it gets the entry via direct memory reference with the LookUP ID. The packet header is updated with the value of LookUP ID for the next neighbor, and forwarded to the proper node according to the entry. [0035] The node receiving such data packet can just use the LookUP ID in the packet header and directly access the table with the ID to get own entry, update the LookUP ID on the packet with next neighbor value in the entry, and forward the packet to the port the entry designates. This process is continued till the packet reaches to the destination. By the direct memory access with the LookUp ID on each node, it can achieve high performance processing without special hardware mechanism such as CAM.

Mesh Network and Routing Path Construction

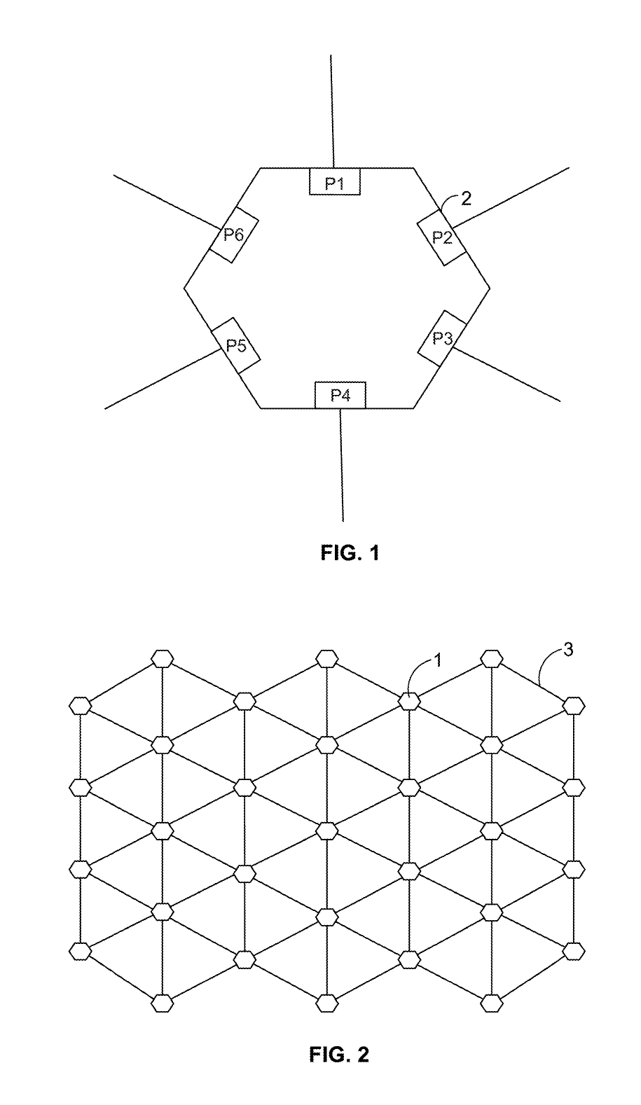

FIG. 1 shows a communication node 1 with six ports 2. These ports 2 are named P1, P2, P3, P4, P5, P6. This example uses 6 ports but another embodiment is not limited to any specific number of ports. Those ports 2 on the node 1 are connected to other nodes to form a mesh network. A port 2 on a node 1 is only connected to a single port 2 on another node, to form a point to point connection.

FIG. 2 shows a mesh network that connects multiple Nodes 1 via communication link 3. Ports 2 are connected to other ports on other node via a link 3. The picture shows a very uniform connection structure, but some embodiments are not limited to such form. The mesh structure may be very random, as long as the link 3 is connected point to point and every node in the mesh can be reachable via multiple hop routing.

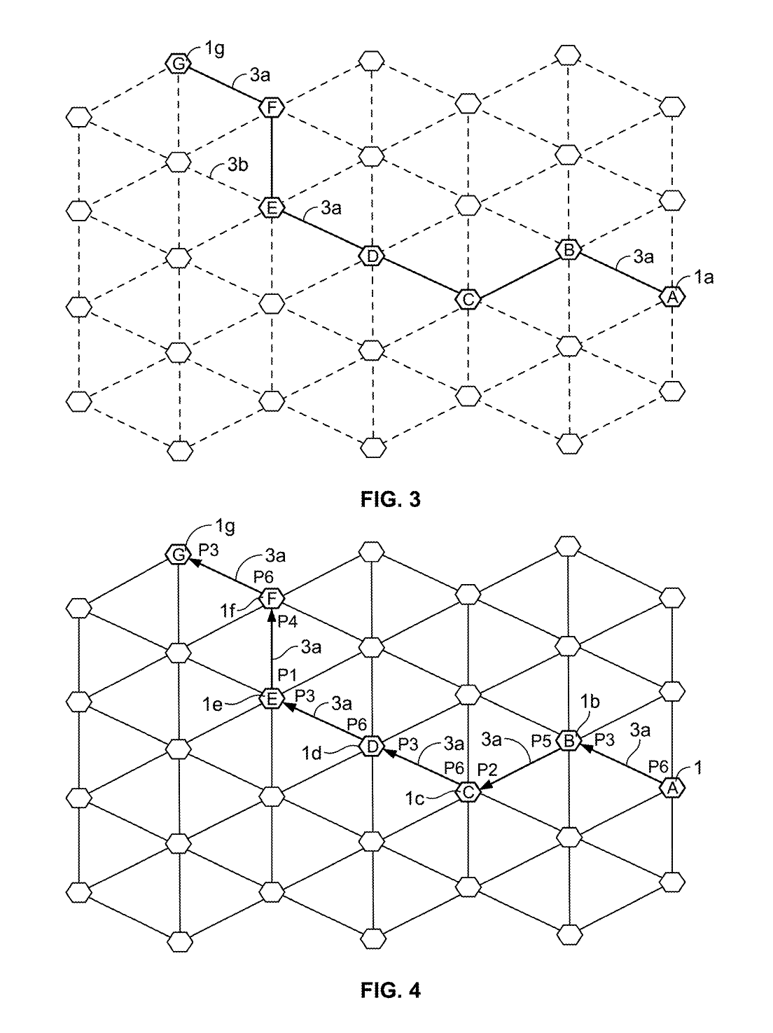

FIG. 3 shows the routing path from node A 1a to node G 1g. Fat lines 3a shows the path from node A 1a to node G 1g, and dashed lines 3b are unused links in the mesh. This routing path is provided by the higher routing protocol.

FIG. 4 shows the steps to construct the routing path from node A 1a to node G 1g. Following the routing path shown in FIG. 3, a route request will be sent from node A 1a, and forwarded to node B 1b, node C 1c, node D 1d, node E 1e, node F 1f, then reached to node G 1g via the routing path 3a. The node outside the mesh 1p shows the port number assignment in each node. During the communication over this routing path, each node creates a proper forwarding entry, and exchanges the LookUP ID with neighbor nodes in the path to form the route path information accessed with LookUp ID directly.

Forwarding Table and Forwarding Entry

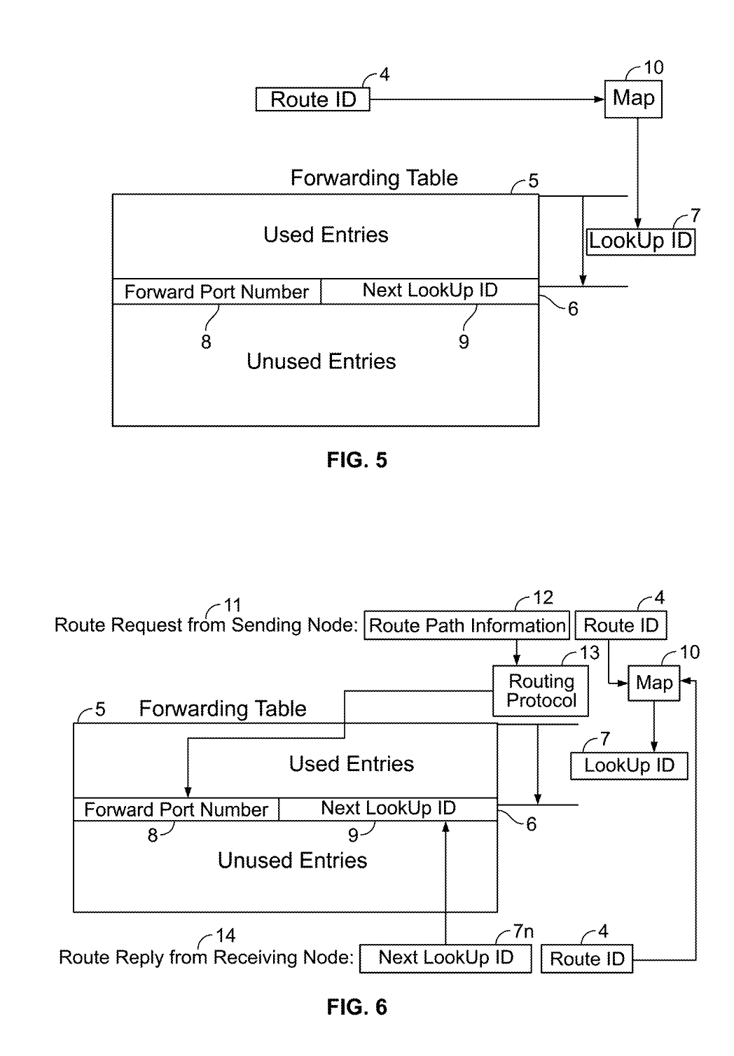

FIG. 5 shows a forwarding table 5 in a node 1. A unique identifier Route ID 4 represents a routing path to send data within the network mesh as shown in FIG. 2. For a new Route ID 4, a new forwarding table entry 6 is allocated within the forwarding table 5. This entry is accessed with linear offset LookUp ID 7. Within a routing entry, it keeps forward port number 8, and Next LookUp ID 9. The forward port number 8 designates the port connected to the next node in the route path. If the port number is set to zero, the packet will be forwarde to upper layer of this node as the destination of the packet. The Next LookUp ID is the LookUp ID in the next node on the routing path.

The Map 10 is a mechanism to map the Route ID 4 to the LookUp ID 7. Each node create the relation between the Route ID 4 and its LookUp ID 7 in the Map 10. This Map 10 can be implemented with hash or other data structure. This Map 10 is only used during the forwarding table construction and the very beginning of the packet transfer to the mesh. So the Map 10 can be located in the upper protocol layer to reduce the size of the Forwarding Table 5.

FIG. 6 shows the process of constructing a forwarding entry 6 in the forwarding table 5. To create a forwarding path for a specific Route ID 4, a Route Request Message 11 is sent from the source node, which contains the information of {Route ID 4, Route Path Information 12}. The node that received such a message allocates a new entry 6 from the unused pool of the Routing Table 5. This entry is accessed with local LookUp ID 7 as a memory offset in the table 5. The Map 10 is updated to have the relation between Route ID 4 and LookUp ID 7. A forwarding port number 8 is calculated by the routing protocol 13 from the route path information 12, and written to the forward entry 6. Then the Route Request Message 11 is forwarded to the next node on the routing path. On the neighbor node, the same process is executed, and the route request is forwarded to the next node. It also returns the Route Reply message 14 with the receiver's LookUp ID 7n and the Route ID 4 to the sender node. The sender node updates the Next LookUp ID field 9 on the forward entry 6 with the LookUP ID 7n on the reply message 14.

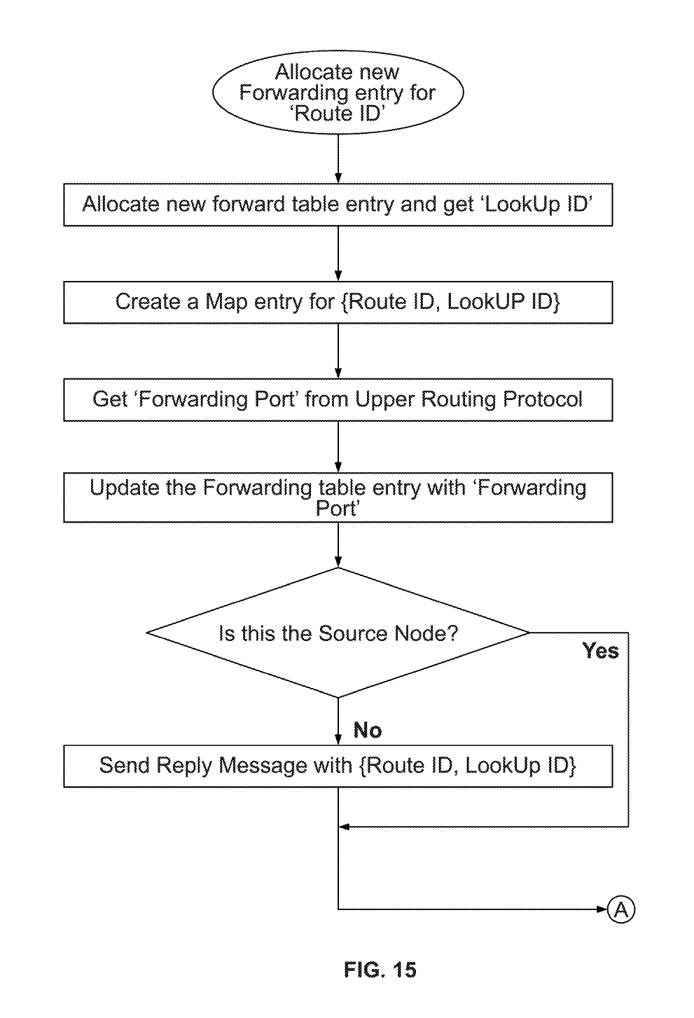

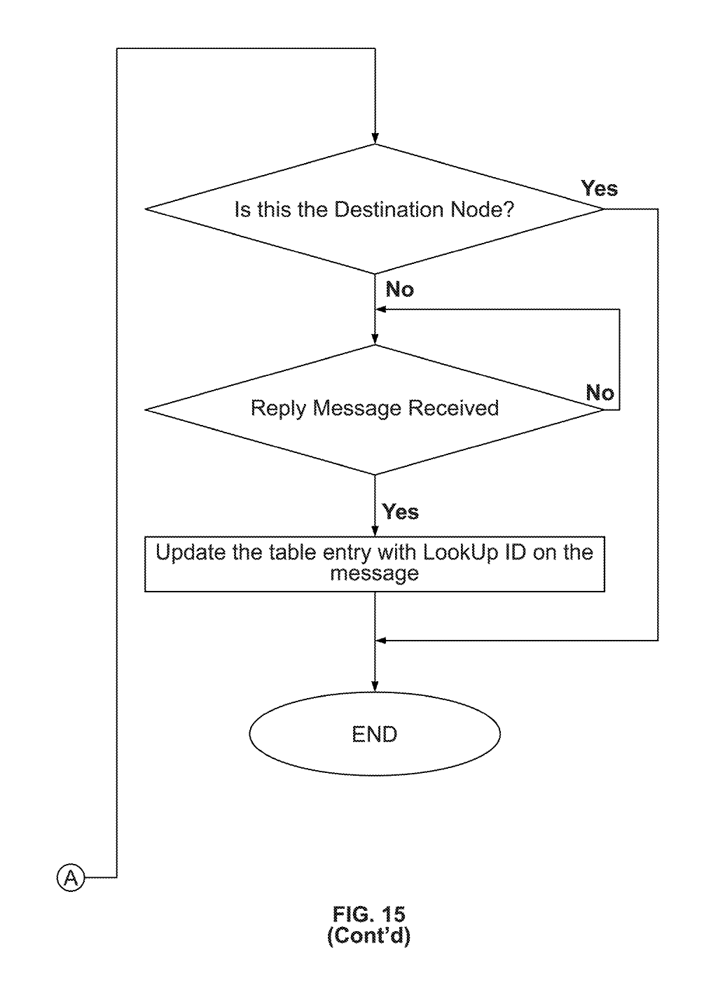

FIG. 15 shows the flow chart of the table entry construction explained above.

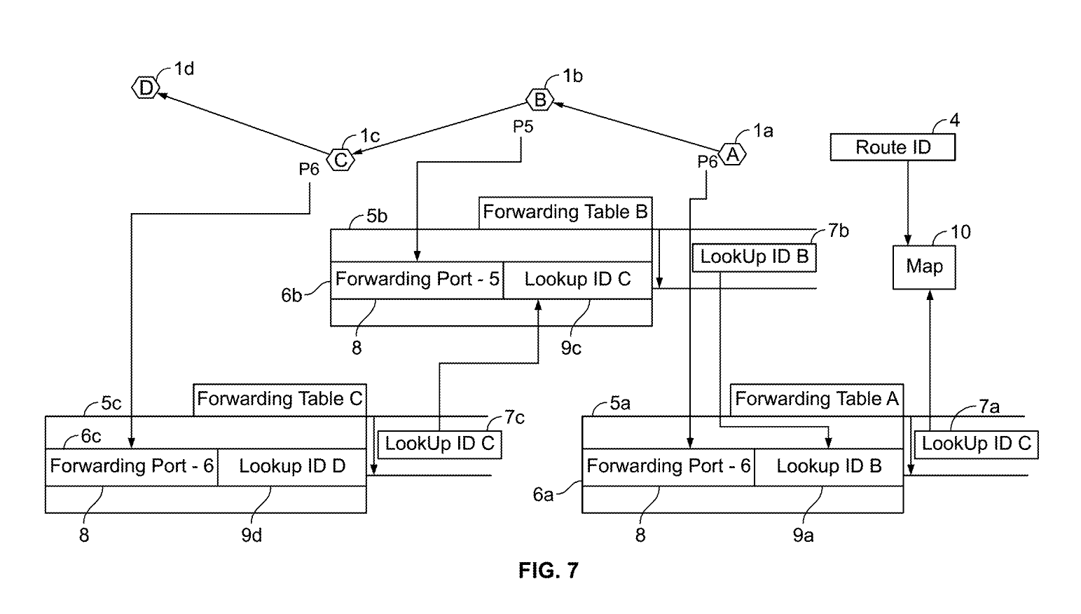

FIG. 7 shows the relation of the route entries in neighbor nodes. The node B 1b is connected to node A on port p6 and the node C 1c is connected to node B on port p5. The node D 1d is connected to node C 1c on port p6. Node A 1b sent the Route Request with the Route ID 4, and node B 1b, node C 1c processed the route request and route reply accordingly. Then the Routing Table A 5a in the node A 1a has the entry 6a for Route ID 4 with the forwarding port number field 8 with port p6 and Next LookUp ID field 9a with LookUp ID B 7b. The entry 6b on the node B 1b stores port number field 8 with port p5, and LookUp ID C 7c on the field 9c. By creating such table entries along the routing path, the packet forwarding chain is created for the given Route ID 4.

Packet Forwarding

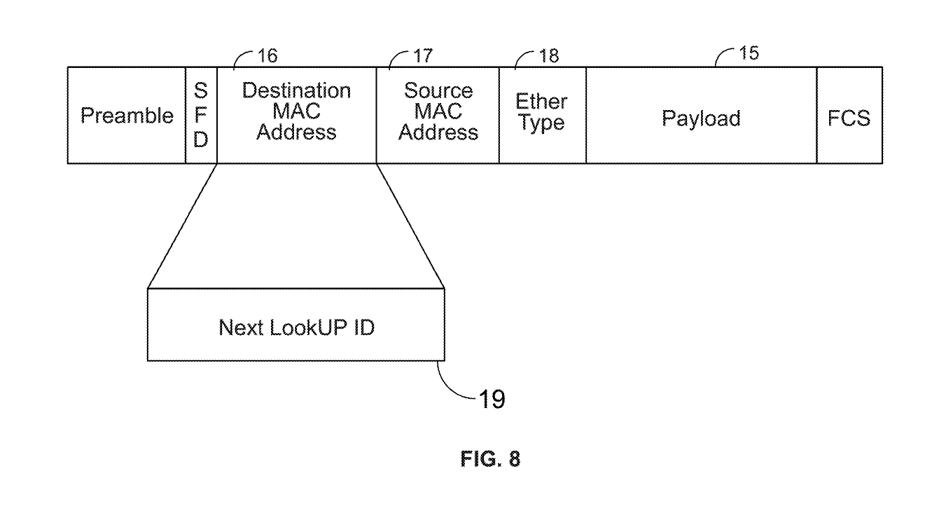

FIG. 8 shows an example usage of the conventional Ethernet packet frame for an embodiment. The Ethernet packet frame 15 is formed with Preamble, SFD, Destination MAC Address 16, Source MAC Address 17, Ether Type 18, Payload, and FCS. As commonly used, the Ethernet packet uses the Destination MAC Address 16 to determine where to route the packet. But in one embodiment, the port is only connected to a single node. Thus, the destination port is not actually needed in this application. Here, we use the Ether Type field 18 with unused type to distinguish from regular Ether packet activity. Then, we use the Destination MAC Address for Next LookUP ID field. This field is updated with the value on the table, when the packet is forwarded to the next node. So that the next node can directly use this field to access to the routing table entry.

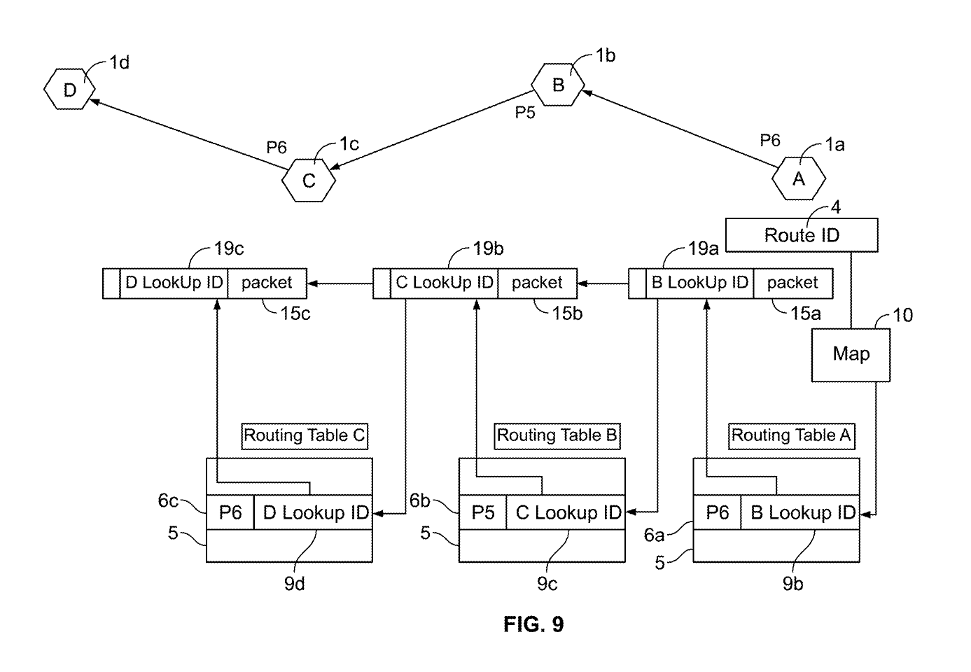

FIG. 9 shows an example of packet forwarding. The source node A 1a sends a packet using the Route ID 4. Node A 1a uses the Map 10 to find the routing table entry 6a corresponding to the Route ID 4. The forwarding port P6 and LookUp ID 9b for node B 1b are found from the entry 6a and the LookUp ID field 19a in the packet 15a is updated to B LookUp ID 9b and forwarded to the node B 1b.

Node B 1b receives the packet 15a and accesses the routing table entry 6b using the LookUp ID field 19a on the packet 15a. With the new entry 6b, forwarding port P5 and C LookUp ID 9c are used from the entry 6b. The LookUp field 19b on the packet 15b is updated with the C LookUp value 9c and forwarded to the node C. The node C 1c process is exactly the same. This process is continued till the packet reached to the destination with the Forward Port Number is set to zero.

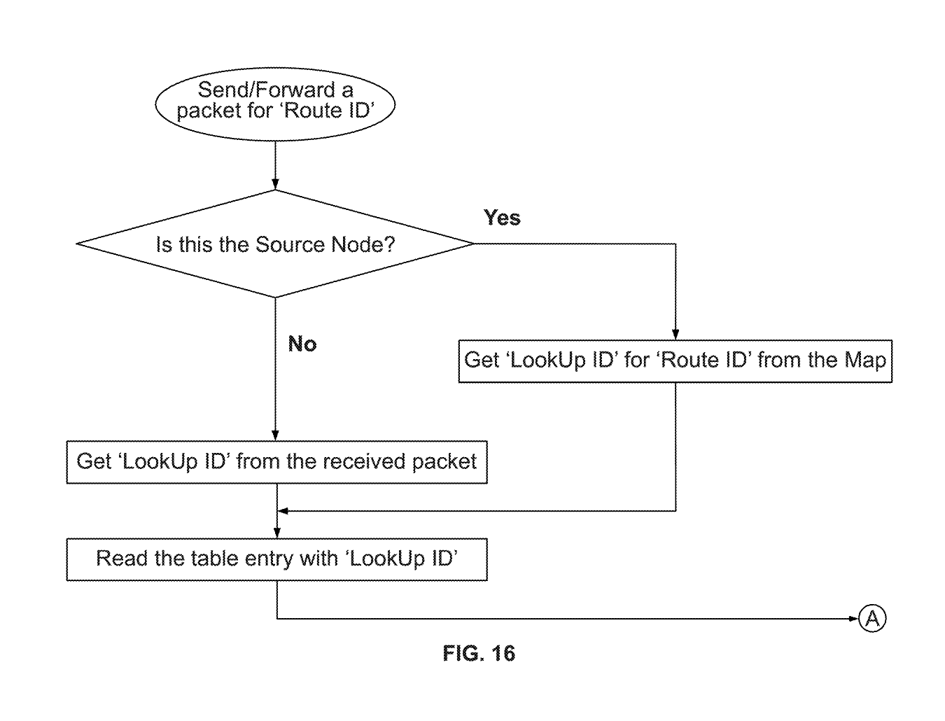

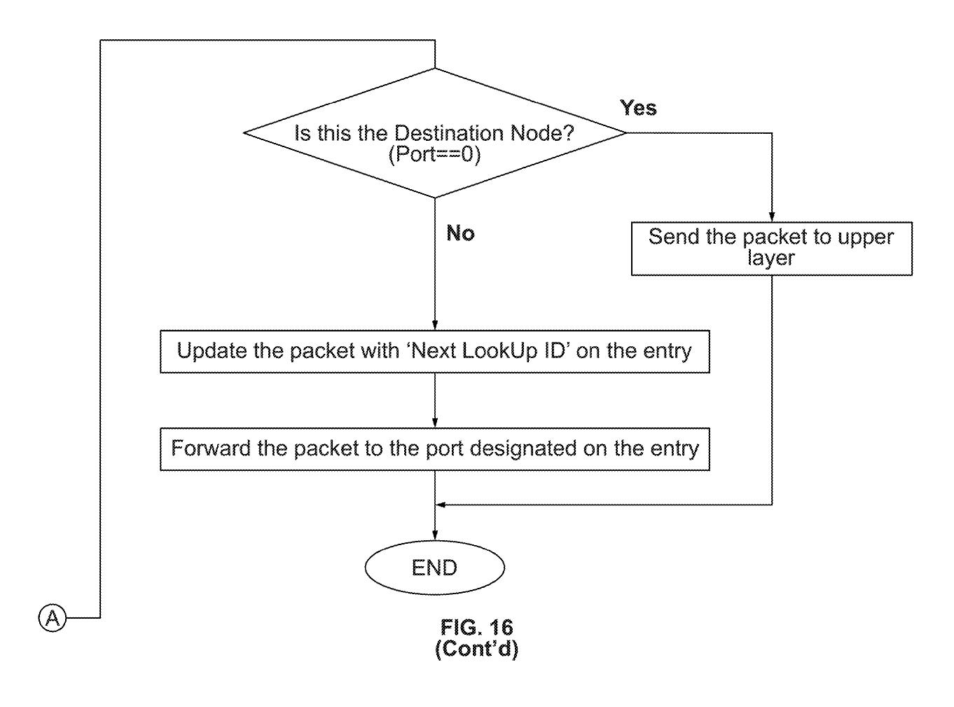

FIG. 16 shows the flow chart of the packet forwarding explained above.

Bidirectional and Multicast Routing

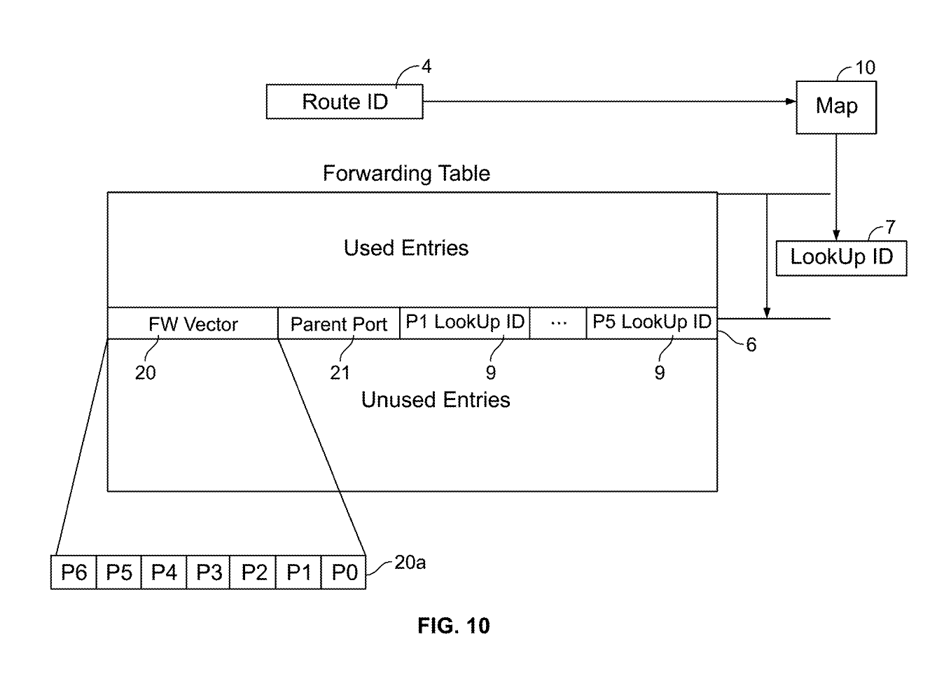

FIG. 10 shows another example of the forwarding table 5 in the node 1 to support bidirectional and multicast transfer. The Route ID 4 is used to represent a routing path in the mesh shown in the FIG. 2. For a new Route ID 4, a new route entry 6 is allocated within the forwarding table 5. This entry is accessed with linear offset LookUp ID 7. The map 10 is used to correspond the Route ID and the LookUp ID as explained in the previous example. Within a routing entry, it keeps the Forward (FW) Vector 20, Parent Port 21, and an array of LookUp ID 9 corresponds to all ports 2. The FW Vector 20 contains bit vector 20a, with bit P1 to P6 correspond to the network ports 2 as shown in FIG. 1, and P0 represents the node itself. When bits in P1 to P6 are set, the packet will be forwarded to the node connected to those ports, and if P0 is set, the packet will be forwarded to upper layer of this node as the destination of the packet. The FW Vector 21 specifies which ports the packet should be forwarded in the case the packet direction is forward. The Parent Port 21 keeps the port that packet should be sent, when the packet direction is backward. The LookUp ID 9 forms an array to keep LookUp ID values for all the ports 2 on the node 1. With this structure, a single Route ID can be used for bidirectional packet transfer. Also, the FW Vector 20 allows to construct the multicast transfer path (explained later).

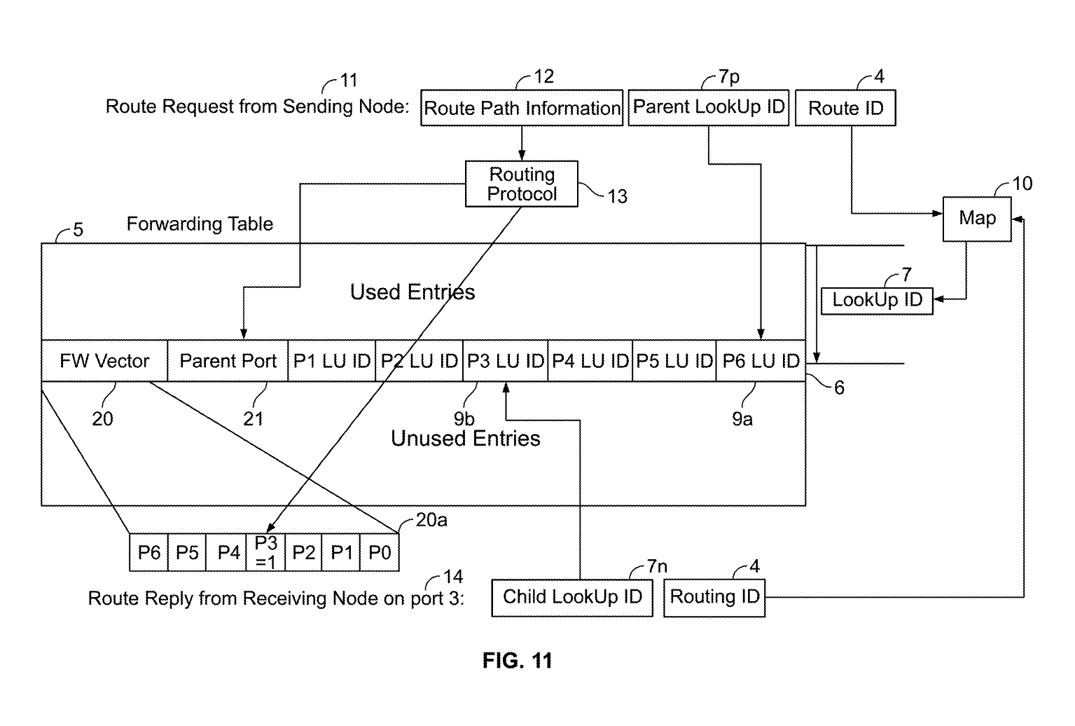

FIG. 11 shows the process of constructing a route entry 6 in the routing table 5 for the example in FIG. 10. To create a routing path for a specific Route ID 4, a Route Request Message 11 is sent from the parent node, which contains the information of {Route ID 4, Route Path Information 12, Parent LookUp ID 7p}. The node that received such a message allocates a new entry 6 from the unused pool of the Routing Table 5. This entry is accessed with local LookUp ID 7 as a memory offset in the table 5. The Map 10 is updated to have the relation between Route ID 4 and LookUp ID 7. The forwarding port vector 20a and the parent port number 21 is calculated by the routing protocol 13 from the route path information 12, and written to the forward entry 6. The Parent LookUp ID 7p from the request message 12 is also written into the entry field 9a. In the figure, P3 bit is set on the FW Vector 20a, and the request is forwarded to the neighbor node connected to P3. On the neighbor node, the same process is executed, and forward the request to the next node with new LookUp ID 7. It also returns the LookUp ID 7n of the new entry for the Route ID 4 as Route Reply 14 to the sending node. The sending node updates the corresponding port LookUp ID 9b with the LookUP ID 7n on the reply message.

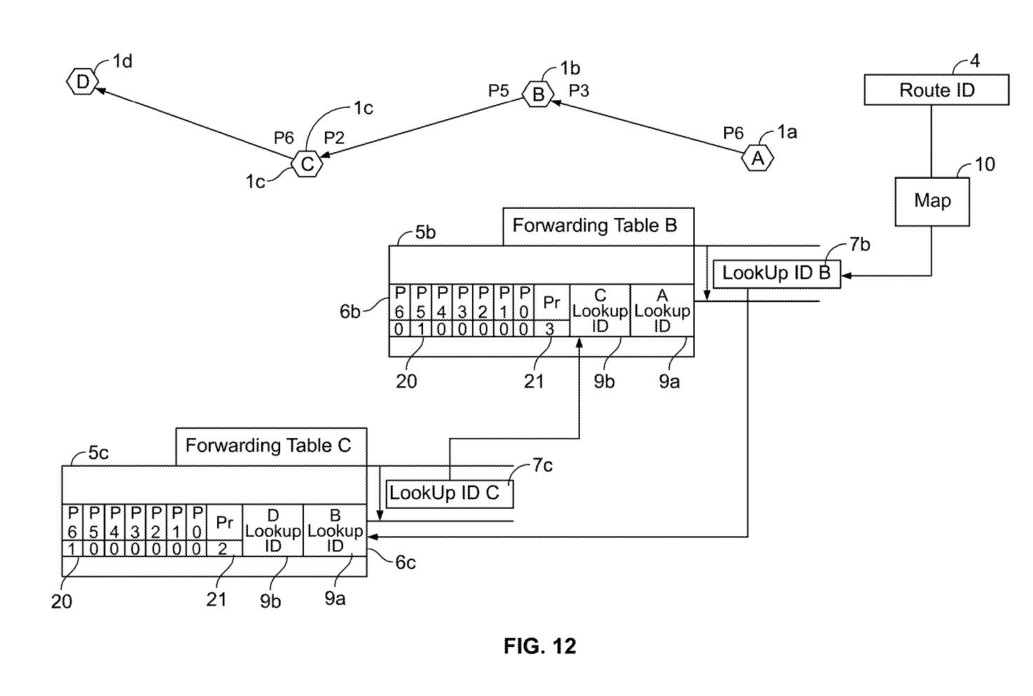

FIG. 12 shows the relation of the forward table entries in neighbor nodes for the example in the FIG. 11. The node B 1b is connected to node A on own port p3, and connected to node C 1c on own port p5. The node C 1c is connected to node B 1b on own port p2 and node D 1d on own port p6. Node A 1b sent the Route Request with own LookUp ID, and node B 1b, node C 1c processed the route request and route reply accordingly. Then the relation between the Route ID 4 and the LookUP ID B 7b is created on the Map 10 on the node 1b, and the Forwarding Table B 5b in the node B 1b has the entry 6b for Route ID 4 with LookUp ID B 7b. The entry 6b stores FW Vector 20 with P5 bit set, Parent Port 21 with value 3, Child LookUp ID 9b with Look Up ID C 7c, and Parent LookUp ID 9a with LookUP ID for node A. The same way, the Routing Table C 5c in node C 1c has the entry 6c for the Route ID 4 with LookUp ID C 7c. The entry 6c stores FW Vector 20 with P6 bit set, Parent Port 21 with value 2, Child LookUp ID 9b with Look Up ID D, and Parent LookUp ID 9a with LookUP ID 7b for node B.

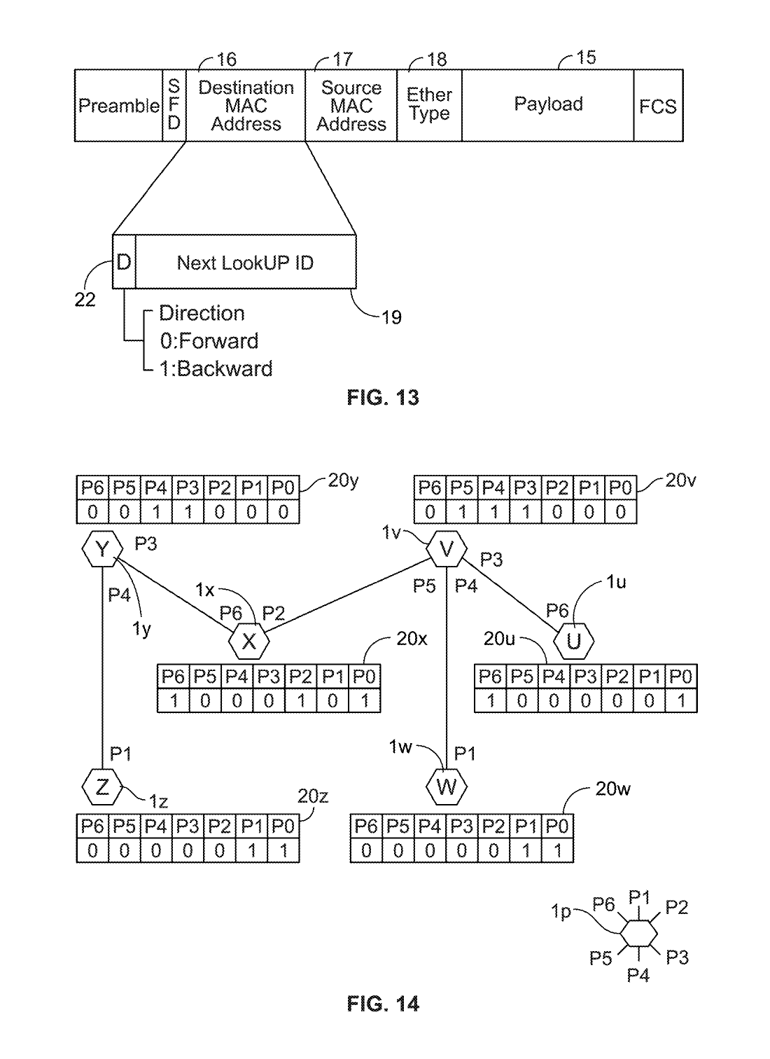

FIG. 13 shows an example usage of the conventional Ethernet packet frame to support the bidirectional transfer. The Ethernet packet frame 15 is formed with Preamble, SFD, Destination MAC Address 16, Source MAC Address 17, Ether Type 18, Payload, and FCS. The same as the FIG. 8, the destination MAC can be used to carry the forwarding information. For bidirectional transfer support, we use MSB of Destination MAC Address as Direction Bit 22, where 0 means forward, and 1 means backward. The rest of the MAC address will be used for Next LookUP ID field 19 for the next node.

When the Direction bit 22 is set to 0 (zero), the packet is forwarded using the FW Vector 20 in the table entry 6. When the Direction bit 22 is set to 1 (one), the packet is transfer backward using the Parent Port 21. So this example can support bidirectional path for a given Route ID 4.

Multicast Routing

FIG. 14 shows an example of multicast routing path. In the figure, multiple nodes, node U 1u, node V 1v, node W 1w, node X 1x, node Y 1y, node Z 1z are part of the mesh network. The nodes U 1u, W 1w, X 1x, Z 1z are the target destination nodes for a specific Route ID, and node Y 1y and node V 1v are the passing node that transfer a packet to next nodes. The FW Vector fields in the routing table entries are shown as 20u, 20v, 20w, 20x, 20y and 20z. For the destination nodes 1u 1w 1x 1z has the P0 bit set, so that the packet received by the node is forwarded to the upper layer of the node. On each node, the received packet is forwarded to all the ports with the FW Vector bit set, except the port where the packet is received. With this rule, the FW Vector 20 and LookUp IDs 9 for all the ports can form the multicast path to any nodes in the mesh network.

This second example uses the FW Vector 20 for constructing multicast mechanism, but this is totally optional and it can carry just the child port number and parent port number if multicasting is not needed. In such case, the size of routing table entry 6 will be reduced and the table size requirement is much smaller. Multicasting can still be implemented using multiple table entries.

V. Generic Computing Device (FIG. 16)

FIG. 9 is a block diagram illustrating an example computing device 900 for use in the system 500A of FIG. 5A, according to one embodiment. The computing device 900 is an exemplary device that is implementable for the authentication server 520A. Additionally, the computing device 900 is merely an example implementation itself, since the system 500A can also be fully or partially implemented with laptop computers, tablet computers, smart cell phones, Internet appliances, and the like.

The computing device 900, of the present embodiment, includes a memory 910, a processor 920, a hard drive 930, and an I/O port 940. Each of the components is coupled for electronic communication via a bus 999. Communication can be digital and/or analog, and use any suitable protocol.

The memory 910 further comprises network applications 912 and an operating system 914. The network applications 912 can include a web browser, a mobile application, an application that uses networking, a remote application executing locally, a network protocol application, a network management application, a network routing application, or the like.

The operating system 914 can be one of the Microsoft Windows® family of operating systems (e.g., Windows 95, 98, Me, Windows NT, Windows 2000, Windows XP, Windows XP x64 Edition, Windows Vista, Windows CE, Windows Mobile), Windows 7, Windows 8, Linux, HP-UX, UNIX, Sun OS, Solaris, Mac OS X, Alpha OS, AIX, IRIX32, or IRIX64. Other operating systems may be used. Microsoft Windows is a trademark of Microsoft Corporation.

The processor 920 can be a network processor (e.g., optimized for IEEE 802.11), a general purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 920 can be single core, multiple core, or include more than one processing elements. The processor 920 can be disposed on silicon or any other suitable material. The processor 920 can receive and execute instructions and data stored in the memory 910 or the storage device 930.

The storage device 930 can be any non-volatile type of storage such as a magnetic disc, EEPROM, Flash, or the like. The storage device 930 stores code and data for applications.

The I/O port 940 further comprises a user interface 942 and a network interface 944. The user interface 942 can output to a display device and receive input from, for example, a keyboard. The network interface 944 connects to a medium such as Ethernet or Wi-Fi for data input and output. In one embodiment, the network interface 944 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Java, JavaScript, PHP, Python, Perl, Ruby, and AJAX. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the one embodiment using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of various techniques have been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use.

I claim:

1. A computer-implemented method for controlling packet transfer in a data communication network where nodes are connected to each other with point to point communication links to form a mesh network, the method for a packet reaching a destination node comprising the steps of:
allocating a unique table entry for given logical routing address on each node;
exchanging a table entry memory address offset with neighbor nodes within a routing path in the mesh network;
holding the neighbor node entry offset in a corresponding table entry; and
upon transferring a packet according to the logical address, the source node finds the routing table entry associated with the logical address and update the specific field on the packet with the table offset value for the neighbor node,
wherein the node on the path uses the field on the received packet to lookup its own table entry, updates the field with a neighbor value on the packet, and forwards the packet.

2. The method of claim 1, wherein the table entry has a bit vector to indicate multiple ports for a given logical address, and a bit to indicate the packet destination is on the node itself, and further comprising the steps of:
when a node receives a packet, forwarding, by the node, the packet to all indicated ports;
forwarding the packet to a node upper computation layer if indicated as the destination to provide multicast capability with a single logical address.

3. The method of claim 1, wherein the entry has at least one forwarding port with the entry offset for the next node, and one port entry for the backward path with the entry offset for the backward node. By having a bit in the packet to indicate the direction, the single logical address supports bidirectional data transfer mechanism.

4. The method of claim 1, wherein the entry has only one forwarding port and one entry offset of the corresponding node to minimize the size of one entry:

5. The method of claim 4, wherein two entries are bundled to represent a bidirectional data transfer mechanism:

6. The method of claim 4, wherein multiple entries are bundled to represent a multicast data transfer mechanism:
